(19) United States
(12) Patent Application Publication
(10) Pub. No.: US 2025/0239052 A1
(43) Pub. Date: Jul. 24, 2025

(54) INFORMATION PROCESSING DEVICE, COMPUTER PROGRAM PRODUCT, AND INFORMATION PROCESSING METHOD

(71) Applicant: KABUSHIKI KAISHA TOSHIBA, Tokyo (JP)

(72) Inventor: Hiroaki TANI, Kawasaki (JP)

(73) Assignee: KABUSHIKI KAISHA TOSHIBA, Tokyo (JP)

(21) Appl. No.: 19/008,749

(22) Filed: Jan. 3, 2025

(30) Foreign Application Priority Data
Jan. 19, 2024 (JP) 2024-006595

(51) Int. Cl. G06V 10/771; G06V 10/774; G06V 40/20

(52) U.S. Cl. CPC G06V 10/771; G06V 10/774; G06V 40/20

(57) ABSTRACT

According to an embodiment, an information processing device includes one or more hardware processors configured to perform: obtaining one or more pieces of first time-series data and one or more pieces of second time-series data; calculating, regarding each of a plurality of first frames included in the first time-series data, a degree of attention indicating a degree at which attention is given in inference performed by a first model configured to receive input of the first time-series data and perform the inference; selecting, from the second time-series data, an N number of second frames using the degree of attention, N being an integer equal to or greater than 1; and performing training-inference including performing training of a second model or performing the inference by the second model using information based on the first time-series data and information based on the selected N number of second frames.

### CROSS-REFERENCE TO RELATED APPLICATIONS

This application is based upon and claims the benefit of priority from Japanese Patent Application No. 2024-006595, filed on Jan. 19, 2024; the entire contents of which are incorporated herein by reference.

### FIELD

Embodiments described herein relate generally to an information processing device, a computer program product, and an information processing method.

### BACKGROUND

A technique has been proposed that inputs time-series data (sequence data) to a machine learning model, and performs a variety of inference. The machine learning model is, for example, a deep learning model. For example, a model has been proposed that receives input of video data capturing a mobile object such as a person or receives input of skeleton sequence data obtained by analyzing video data, and performs inference about the actions of the mobile object (the behavior of the person).

If the inference is performed using a plurality of types of time-series data, it is expected to have an enhancement in the accuracy of the inference. On the other hand, since the time-series data contains data (frames) having a plurality of times, in a configuration in which a plurality of pieces of time-series data is used, there is a risk of an increase in the amount of calculation of the operations such as inference and learning performed by a machine learning model.

### BRIEF DESCRIPTION OF THE DRAWINGS

FIG. 1 is a block diagram illustrating an information processing device according to a first embodiment;

FIG. 2 is a diagram illustrating an example of time-series data that is obtained;

FIG. 3 is a diagram illustrating a case in which a single frame has the highest degree of attention;

FIGS. 4 and 5 are diagrams illustrating examples to which selection methods are applied;

FIG. 6 is a block diagram illustrating a training-inference unit according to the first embodiment;

FIG. 7 is a flowchart for explaining the information processing according to the first embodiment;

FIG. 8 is a diagram illustrating an example of the inference result output by an output control unit;

FIG. 9 is a block diagram illustrating an information processing device according to a second embodiment;

FIG. 10 is a block diagram illustrating a training-inference unit according to the second embodiment;

FIG. 11 is a block diagram illustrating an information processing device according to a third embodiment;

FIG. 12 is a block diagram illustrating a training-inference unit according to the third embodiment; and

FIG. 13 is a diagram illustrating a hardware configuration of the information processing device according to the first to third embodiments.

### DETAILED DESCRIPTION

According to an embodiment, an information processing device includes one or more hardware processors. the one or more hardware processors are configured to perform: obtaining one or more pieces of first time-series data and one or more pieces of second time-series data, types of the one or more pieces of first time-series data being different from each other, types of the one or more pieces of second time-series data being different from the types of the one or more pieces of first time-series data and being different from each other; calculating, regarding each of a plurality of first frames included in the first time-series data, a degree of attention indicating a degree at which attention is given in inference performed by a first model configured to receive input of the first time-series data and perform the inference; selecting, from the second time-series data, an N number of second frames using the degree of attention, N being an integer equal to or greater than 1; and performing training-inference including performing training of a second model configured to perform the inference or performing the inference by the second model using information based on the first time-series data and information based on the selected N number of second frames.

Preferred embodiments of an information processing device according to the present invention are described below in detail with reference to the accompanying drawings.

The following explanation is mainly given about an exemplary configuration in which a model is used that receives input of a plurality of types of time-series data (sequence data) and that estimates (infers) the behavior of a person. Herein, the inference applicable in the embodiments described below is not limited to the estimation of the behavior of a person, and it is possible to apply any type of inference performed using time-series data. For example, it is possible to have a configuration in which the actions of a non-human mobile object such as an animal or a robot are estimated.

The time-series data contains a plurality of pieces of data (frames) continuous in chronological order. Each of the frames included in the time-series data represents, for example, one of the following types of data. However, those are not the only possible examples.
color image data (for example, RGB image data)
skeleton data
optical flow data
depth image data
regional division image data
infrared image data
X-ray image data
audio data

Meanwhile, the types of data (time-series data) are sometimes called the modals of data or the formats of data. The embodiments described below may also be interpreted to be an example of performing inference using multimodal time-series data.

As explained above, as a result of performing inference using a plurality of types of time-series data, it becomes possible to enhance the accuracy of the inference. Depending on the type of the time-series data, sometimes it is not necessary to use all of the frames included in the time-series data for the intended inference.

For example, consider a case in which the action of eating a particular food item as performed by a particular person is estimated using the time-series data of the skeleton data (hereinafter, called skeleton sequence data) and using the time-series data of the color image data (hereinafter, called video data). In such a case, the action of eating a food item may be estimated using, for example, the skeleton sequence data containing a plurality of frames. On the other hand, the food item being eaten may be possibly estimated using, for example, only those frames in which the food item is captured from among the frames included in the video data.

Thus, in the case where inference is performed using a plurality of types of time-series data, regarding some of the types of time-series data, even when the inference is performed using only some of the frames instead of using all of the frames included in the time-series data, the accuracy of inference may still be enhanced.

### First Embodiment

An information processing device according to a first embodiment performs predetermined inference using a plurality of types of time-series data. At that time, in the first embodiment, using the degree of attention of each frame calculated from a particular type of time-series data (hereinafter, called time-series data SDA), N number of frames (where N is an integer equal to or greater than 1) are selected (hereinafter, called frame data FDB) from other types of time-series data (hereinafter, time-series data SDB), and the inference is performed using the selected frame data FDB. As a result, as compared to a configuration in which the inference is performed using the time-series data SDB that contains all frames, it becomes possible to reduce the amount of calculation.

The degree of attention represents the information indicating the degree at which attention is given in the inference performed using the time-series data SDA. Then, for example, frame data FDB at the time corresponding to the frame having the highest degree of attention is selected. Hence, even without using the time-series data SDB that contains all frames, it becomes possible to enhance the accuracy of the processing performed using a machine learning model.

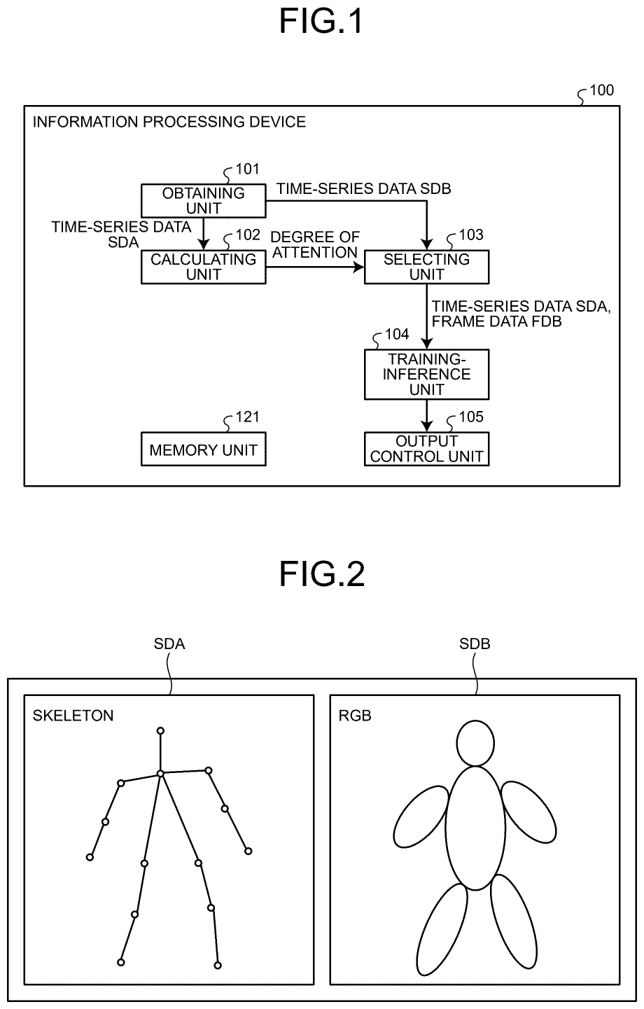

FIG. 1 is a block diagram illustrating an exemplary configuration of an information processing device 100 according to the first embodiment. As illustrated in FIG. 1, the information processing device 100 includes an obtaining unit 101, a calculating unit 102, a selecting unit 103, a training-inference unit 104, an output control unit 105, and a memory unit 121.

The obtaining unit 101 obtains a variety of information used in the information processing device 100. For example, the obtaining unit 101 obtains one or more pieces of time-series data SDA (pieces of first time-series data) that are of mutually different types, and obtains one or more pieces of time-series data SDB (pieces of second series data) that are of different types than the time-series data SDA and that are of mutually different types.

In the first embodiment, the following explanation is given about an example in which a single set of time-series data SDA is obtained and a single set of time-series data SDB is obtained. An example in which two pieces of time-series data SDB are used is explained in a second embodiment. An example in which two pieces of time-series data SDA are used is explained in a third embodiment. If the second and third embodiments are combined, it becomes possible to have a configuration in which two or more pieces of time-series data SDA are used and two or more pieces of time-series data SDB are used.

As explained later, the time-series data SDA is equivalent to the time-series data from which all frames are used in behavior estimation. On the other hand, the time-series data SDB is equivalent to the time-series data from which N number of frames are selected and the selected frames are used in behavior estimation.

The time-series data SDA and the time-series data SDB may have the same start time and the same end time. That eliminates the need to perform the operation of associating the times among a plurality of pieces of time-series data.

If a plurality of pieces of time-series data has different frame rates, for example, the obtaining unit 101 performs an operation for interpolating the frames regarding the time-series data having low frame rates, and ensures that the frame rate is same among a plurality of pieces of time-series data.

The time-series data having a large data volume may be obtained as the time-series data from which the frames are selected. Thus, the data volume of the time-series data SDB may be greater than the data volume of the time-series data SDA. As a result, it becomes possible to reduce more data volume.

For example, the obtaining unit 101 may obtain skeleton sequence data as the time-series data SDA, and may obtain video data as the time-series data SDB. For example, the skeleton sequence data represents the coordinate data of the time series expressing the joint points of a person. The skeleton sequence data may be obtained according to an arbitrary method. For example, the skeleton sequence data may be obtained according to a skeleton detection method such as Openpose, or according to a method in which a sensor is used.

In the following explanation, it is assumed that a single person represents the estimation target. When the data of a plurality of persons is included in the time-series data, the obtaining unit 101 may use an object detector to generate time-series data that contains data clipped on a person-by-person basis. In the case where inference other than the estimation of the actions of a person is performed, it is not necessary to perform the operation clipping the data on a person-by-person basis using an object detector.

FIG. 2 is a diagram illustrating an example of the time-series data that is obtained. In FIG. 2 is illustrated an example of the time-series data SDA containing skeleton data as frames and an example of the time-series data SDB containing RGB image data as frames. Meanwhile, in FIG. 2, although only a single frame is illustrated, each set of time-series data contains a plurality of frames.

The calculating unit 102 calculates the degree of attention regarding each of a plurality of frames (first frames) included in the time-series data SDA. The degree of attention indicates the degree at which attention is given in the inference performed using a model MA (a first model) that is configured to receive input of the time-series data SDA and perform inference.

A frame having a high degree of attention may be interpreted as a frame that is important in the inference performed using the model MA, or as a frame serving as the basis of the inference performed using the model MA, or as a frame having a significant contribution in the inference performed using the model MA. Thus, the degree of attention may also be referred to as the degree of importance or the degree of contribution.

When the skeleton sequence data is used as the time-series data SDA, for example, the model MA may be a deep learning model such as ST-GCN (Spatial Temporal Graph Convolutional Network) that, regarding each of a plurality of frames included in the skeleton sequence data, outputs the output data, which contains the degree of attention in the temporal axis, as the result of inference (inference result).

For example, ST-GCN receives input of the skeleton sequence data and outputs a feature (an example of the output data) including three-dimensional elements of (the skeleton points, the number of persons, and the degree of attention in the temporal axis). The calculating unit 102 may use the model MA and calculate the degree of attention in the temporal axis as the degree of attention of each frame.

For example, the calculating unit 102 implements a dimensional compression method such as Global Average Pooling and compresses, from among the elements included in the feature, the elements in the other dimensionalities other than the degree of attention in the temporal axis; and calculates the feature that includes only the degree of attention in the temporal axis. That feature is equivalent to the degree of attention of each frame (the degree of attention in the temporal axis). It is assumed that, greater the degree at which attention is given in the inference, the greater is the value of the degree of attention. Meanwhile, it is also possible to have a configuration in which dimensional compression is not performed and, for example, the degree of attention is calculated for each skeleton point, and the degree of attention having the highest value is used from among the degrees of attention of the skeleton points.

However, the method for calculating the degree of attention is not limited to the method explained above. Thus, as long as the degree at which attention is given in the inference based on the model MA may be calculated for each of a plurality of frames included in the time-series data SDA, it is possible to implement any other method.

The selecting unit 103 uses the degrees of attention calculated by the calculating unit 102 and selects, from the time-series data SDB, the frame data FDB representing the N number of frames (second frames).

For example, as the frame data FDB, the selecting unit 103 selects frames in the time-series data SDB at the same time as the time of the frames having the highest degree of attention. When a single frame has the highest degree of attention, the selecting unit 103 selects a single (N=1) set of frame data FDB.

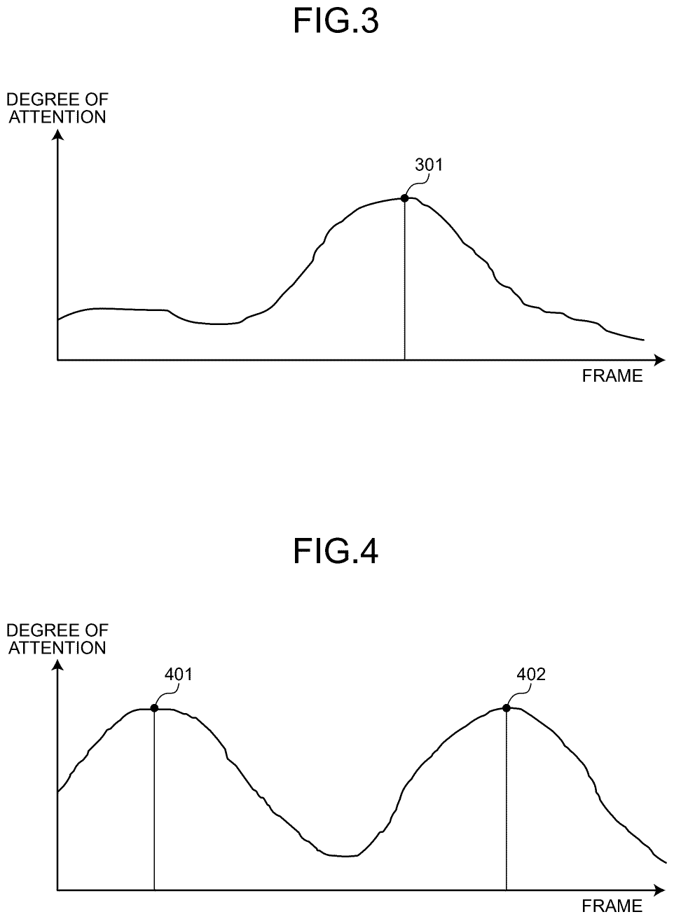

FIG. 3 is a diagram illustrating a case in which a single frame has the highest degree of attention. In FIG. 3 is illustrated an exemplary graph indicating the value of the degree of attention of each of a plurality of frames included in the time-series data SDA. In the example illustrated in FIG. 3, an attention degree 301 represents the degree of attention having the highest value. In that case, the selecting unit 103 selects, as the frame data FDB from the time-series data SDB, a single frame at the same time as the frame of the attention degree 301.

When there are two or more frames having the highest degree of attention, the selecting unit 103 may select, as the frame data FDB from the time-series data SDB, two or more frames at the same times as the two or more frames having the highest degree of attention.

The method by which the selecting unit 103 selects a frame is not limited to the method for selecting the frame corresponding to the frame having the highest degree of attention. Alternatively, for example, the selecting unit 103 may apply the following selection methods.
selection method 1-1: selecting, as the frame data FDB, N number of frames at the same times as the N number of frames having the degree of attention to be equal to the local maximum value are selected as the frame data FDB, from among a plurality of frames included in the time-series data SDB.
selection method 1-2: selecting, as the frame data FDB, a fixed number of frames in descending order of the degrees of attention are selected as the frame data FDB or such N number of frames at the same times as the N number of frames within a certain proportion (for example, top M %), from among a plurality of frames included in the time-series data SDB.
selection method 1-3: selecting, as the frame data FDB, N number of frames at the same times as the N number of frames having the degrees of attention to be greater than a threshold value, from among a plurality of frames included in the time-series data SDB.

FIG. 4 is a diagram illustrating an example to which the selection method 1-1 is applied. In the example illustrated in FIG. 4, attention degrees 401 and 402 represent the degrees of attention equal to the local maximum value. For example, as the degrees of attention equal to the local maximum value, the selecting unit 103 may identify the degrees of attention corresponding to the points for which the derivative value changes from a positive value to a negative value regarding the function for expressing the change in the degree of attention with respect to the frame.

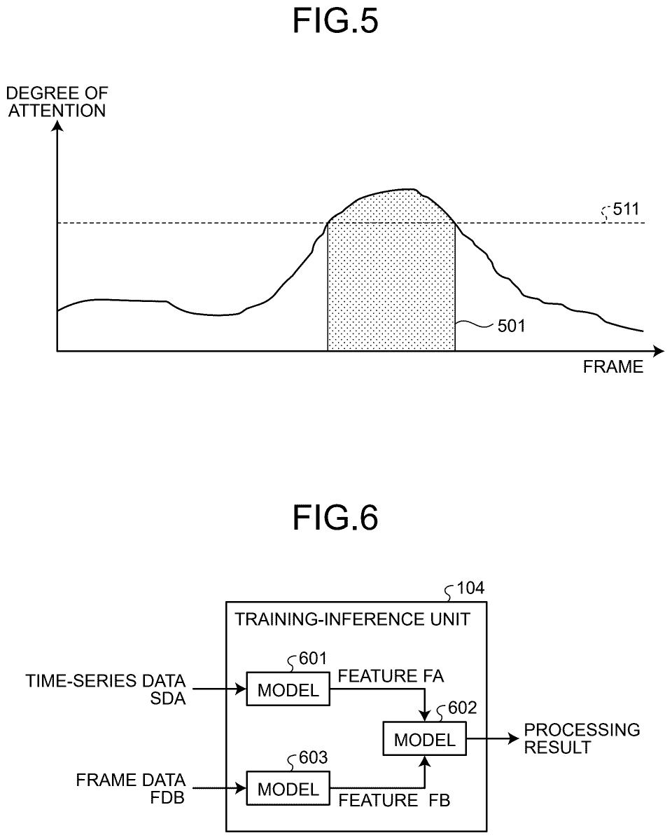

FIG. 5 is a diagram illustrating an example to which the selection method 1-2 is applied. In the example illustrated in FIG. 5, a plurality of frames included in a range 501, which includes M % of the frames in descending order of the degrees of attention, is selected as the frame data FDB. FIG. 5 may also be interpreted to be an example to which the selection method 1-3 is applied. For example, a plurality of frames included in the range, which includes N number of frames having the degrees of attention to be greater than a threshold value 511, is selected as the frame data FDB.

Returning to the explanation with reference to FIG. 1, the training-inference unit 104 performs training of a model MB (a second model) configured to perform inference, or performs inference, using the information that is based on the time-series data SDA, and the information that is based on the selected N number of pieces of frame data FDB.

FIG. 6 is a block diagram illustrating an exemplary configuration of the training-inference unit 104. As illustrated in FIG. 6, the training-inference unit 104 includes a model 601, a model 602, and a model 603 (a third model).

The model 601 receives input of the time-series data SDA, performs inference, and outputs the inference result. In the example illustrated in FIG. 6, the model 601 outputs a feature FA (a first feature) as the inference result. For example, the model 601 is the same model as the model MA that is used by the calculating unit 102 at the time of calculating the degrees of attention.

The model 603 receives input of the frame data FDB, performs inference, and outputs the inference result. In the example illustrated in FIG. 6, the model 603 outputs a feature FB (a second feature) as the inference result. For example, the model 603 may be a deep learning model such as EfficientNet that receives input of the frame data FDB and outputs the inference result.

The model 603 may be configured to perform batch processing of N number of frames, that is, to receive collective input of N number of frames and output N number of inference results. Alternatively, the model 603 may be configured to receive input of N number of frames one by one, and output a single inference result at a time. In the latter case, the model 603 repeatedly performs inference for N number of times and obtains N number of inference results. When a plurality of inference results is obtained (i.e., when N≥2 holds true), a statistical value (the average value or the median value) of the inference results may be used as the final inference result obtained by the model 603. Still alternatively, the model 603 may be configured to receive collective input of N number of frames and output only a single inference result.

The model 602 uses the inference results obtained by the models 601 and 603, and outputs the final inference result. In the example illustrated in FIG. 6, the model 602 is equivalent to the model MB that performs inference using the feature FA representing an example of the information based on the time-series data SDA and using the feature FB representing an example of the information based on the selected N number of pieces of frame data FDB. For example, the model 602 (the model MB) is trained to output the inference result using the features FA and FB as input.

Meanwhile, in the case where inference is performed, the training-inference unit 104 outputs, as the processing result, the inference result obtained by the model 602.

When performing training, the training-inference unit 104 trains each model using the data for learning. The training method implemented by the training-inference unit 104 may be any method that is implementable with respect to each model. For example, the training-inference unit 104 calculates the value of a loss function using the output (the inference result) of the model 602, and trains the model 602 to optimize the value of the loss function.

The training-inference unit 104 may train at least either the model 601 (the model MA) or the model 603 along with the model 602 (the model MB). For example, the training-inference unit 104 may train the parameters of the model 601, the parameters of the model 602, and the parameters of the model 603 to optimize the value of the loss function. The processing result obtained when performing training indicates, for example, the parameters representing the trained models.

Meanwhile, when the training-inference unit 104 trains the model 601 along with the model 602, the calculating unit 102 calculates the degrees of attention using the model 601 that is being trained. On the other hand, when the training-inference unit 104 does not train the model 601 along with the model 602, the calculating unit 102 calculates the degrees of attention using the already-trained model 601.

The configuration of the training-inference unit 104 is not limited to the configuration illustrated in FIG. 6. Alternatively, for example, the model 601 (the model MA) may be configured to output probability information PA as the inference result (a first inference result), instead of outputting the feature FA. Moreover, the model 603 may be configured to output probability information PB as the inference result (a second inference result), instead of outputting the feature FB. The probability information contains, for example, probability values indicating the probability of a plurality of predetermined inference results (such as the behavior of a plurality of persons).

In that case, the model 602 receives input of the probability information PA (another example of the information based on the time-series data SDA) and the probability information PB (another example of the information based on the selected N number of pieces of frame data FDB), and outputs the inference result. For example, the model 602 outputs, as the inference result, the probability information obtained by adding the probability information PA and the probability information PB.

Returning to the explanation with reference to FIG. 1, the output control unit 105 controls the output of a variety of information used in the information processing device 100. For example, the output control unit 105 outputs the inference result obtained by the training-inference unit 104. The inference result may include the selected N number of pieces of frame data FDB.

The selected pieces of frame data FDB are equivalent to the frames having high degrees of attention, that is, the frames to which attention is given in the inference, or the frames serving as the basis for the inference, or the frames important in the inference. Thus, as a result of outputting the selected pieces of frame data FDB, it becomes possible to figure out the basis for the inference.

The output control unit 105 may output the output information according to any method. For example, it is possible to apply the method for displaying the information in a display device such as a display, or the method for transmitting the information to external devices connected via a network.

At least some of the constituent elements explained above (i.e., the obtaining unit 101, the calculating unit 102, the selecting unit 103, the training-inference unit 104, and the output control unit 105) may be implemented using one or more processing units. For example, the constituent elements are implemented using one or more processors. For example, the constituent elements may be implemented by causing a processor such as a central processing unit (CPU) or a graphics processing unit (GPU) to execute computer programs, that is, may be implemented using software. Alternatively, the constituent elements may be implemented using a processor such as a dedicated integrated circuit (IC), that is, may be implemented using hardware. Still alternatively, the constituent elements may be implemented using a combination of software and hardware. In the case where a plurality of processors is used, each processor either may implement one of the constituent elements or may implement two or more constituent elements.

The memory unit 121 is used to store a variety of information that is used in the information processing device. For example, the memory unit 121 is used to store: the information obtained by the obtaining unit 101 (the time-series data SDA and the time-series data SDB); the frame data FDB selected by the selecting unit 103; and the inference result obtained by the training-inference unit 104.

The memory unit 121 may be configured using any commonly-used memory medium such as a flash memory, a memory card, a random access memory (RAM), a hard disk drive (HDD), or an optical disc.

The information processing device 100 may be physically configured either using a single device or using a plurality of devices. For example, the information processing device 100 may be built in a cloud environment. Meanwhile, the constituent elements of the information processing device 100 may be dispersedly included across a plurality of devices.

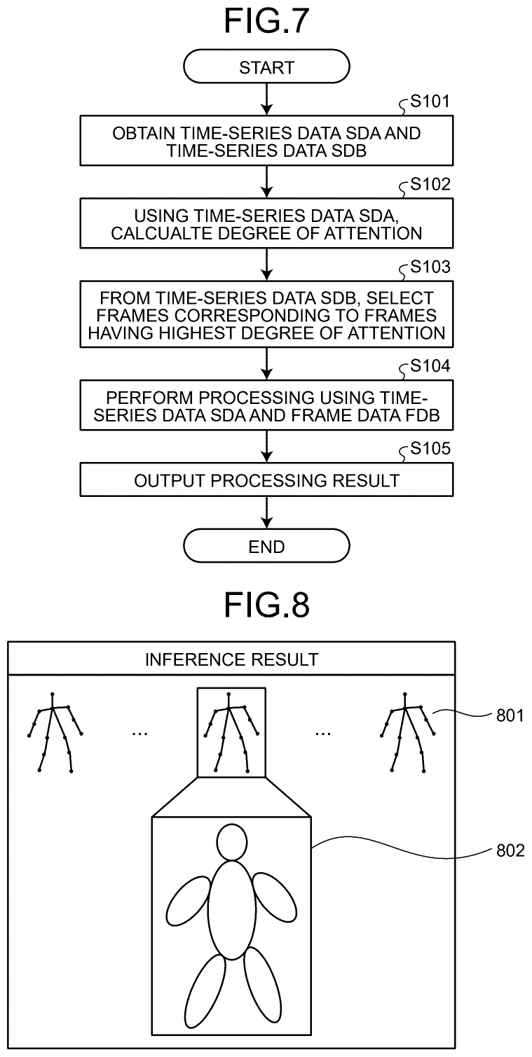

Given below is the explanation of the information processing performed by the information processing device 100 according to the first embodiment. FIG. 7 is a flowchart for explaining an example of the information processing according to the first embodiment.

The obtaining unit 101 obtains the time-series data SDA and the time-series data SDB (Step S101). The calculating unit 102 uses the time-series data SDA and calculates the degree of attention of each frame included in the time-series data SDA (Step S102). The selecting unit 103 uses the degrees of attention and selects N numbers of frames (pieces of frame data FDB) from the time-series data SDB (Step S103). For example, the selecting unit 103 selects, from the time-series data SDB, the pieces of frame data FDB corresponding to the frames having the highest degree of attention. The training-inference unit 104 performs processing (inference or training) using the time-series data SDA and the frame data FDB (Step S104). The output control unit 105 outputs the processing result (the inference result or the training result) (Step S105). That marks the end of the information processing.

FIG. 8 is a diagram illustrating an example of the inference result output by the output control unit 105. In the example illustrated in FIG. 8, the output control unit 105 outputs skeleton sequence data 801 that represents the time-series data SDA that was input; and outputs a frame 802 that is equivalent to the frame data FDB selected by the selecting unit 103. For example, when the time-series data SDA is stored as a video file; the output control unit 105 may store, as the basis for determination, the selected frame data FDB in the form of the thumbnail of the video file.

In this way, in the first embodiment, inference is performed using the time-series data of a particular type and using the frames of the time-series data of another type that are selected according to the degrees of attention calculated from the particular type of time-series data. As a result, as compared to the inference performed using a single set of time-series data, it becomes possible to enhance the accuracy of the processing. Meanwhile, regarding some pieces of time-series data, selected frames are used for inference instead of using the time-series data in entirety. As a result, as compared to the configuration in which the inference is performed using the time-series data SDB that contains all frames, it becomes possible to reduce the amount of calculation.

Moreover, as a result of performing inference using the selected frames, it also becomes possible to reduce the load attributed to building a model for the purpose of inference. For example, regarding a model that performs inference using only some of the frames (for example, a single frame) instead of using the time-series data in entirety, it is possible to have a configuration in which a model is used that is trained in advance using large learning data made open to the public.

### Second Embodiment

In the first embodiment, frames are selected from only a single type of time-series data. However, there may be two or more types of time-series data from which the frames are selected. In a second embodiment, the explanation is given about an example in which the frames are selected from each of two types of time-series data.

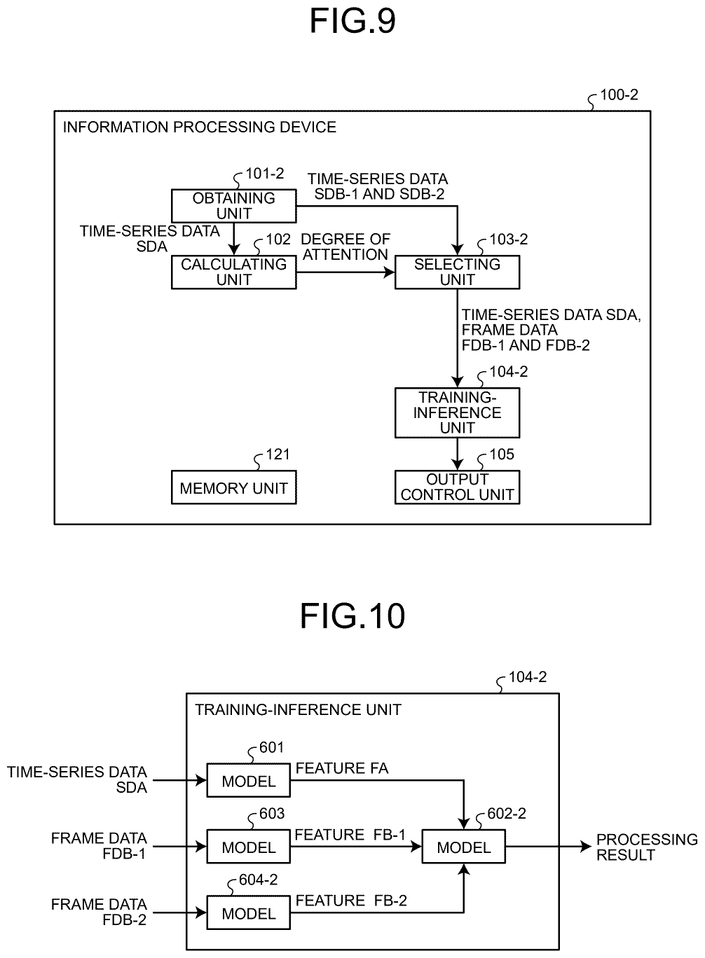

FIG. 9 is a block diagram illustrating an exemplary configuration of an information processing device 100-2 according to the second embodiment. As illustrated in FIG. 9, the information processing device 100-2 includes an obtaining unit 101-2, the calculating unit 102, a selecting unit 103-2, a training-inference unit 104-2, the output control unit 105, and the memory unit 121.

In the second embodiment, the obtaining unit 101-2, the selecting unit 103-2, and the training-inference unit 104-2 have different functions than the functions according to the first embodiment. The other configurations and the other functions are identical to FIG. 1 illustrating the block diagram of the information processing device 100 according to the first embodiment. Hence, they are referred to by the same reference numerals, and their explanation is not given again.

The obtaining unit 101-2 obtains a single set of time-series data SDA and obtains two pieces of time-series data SDB-1 and SDB-2 of mutually different types. For example, the time-series data SDA represents skeleton sequence data; the time-series data SDB-1 represents video data; and the time-series data SDB-2 represents sequence data of the optical flow calculated from the video data (the time-series data SDB-1).

The selecting unit 103-2 selects N number of frames from each of the two pieces of time-series data SDB-1 and SDB-2. In the following explanation, the frames selected from the time-series data SDB-1 are referred to as frame data FDB-1, and the frames selected from the time-series data SDB-2 are referred to frame data FDB-2.

Regarding each set of time-series data (the time-series data SDB-1 and the time-series data SDB-2), the method for selecting the frames is identical to the method implemented by the selecting unit 103 according to the first embodiment. For example, the selecting unit 103-2 selects, as the frame data FDB-1 (FDB-2), frames in the time-series data SDB-1 (SDB-2) at the same time as the time of the frame having the highest degree of attention.

The training-inference unit 104-2 uses the information that is based on the time-series data SDA and uses the information that is based on the N number of pieces of frame data FDB-1 and FDB-2, and performs training of the model MB or inference.

FIG. 10 is a block diagram illustrating an exemplary configuration of the training-inference unit 104-2. As illustrated in FIG. 10, the training-inference unit 104-2 includes models 601, 602-2, 603, and 604-2. Regarding the same configuration as the training-inference unit 104 according to the first embodiment, the same reference numerals are used and the same explanation is not given again.

The model 603 is identical to FIG. 6, except for the fact that the frame data FDB and the feature FB are referred to as the frame data FDB-1 and a feature FB-1.

The model 604-2 receives input of the frame data FDB-2 and performs inference, and outputs the inference result. In the example illustrated in FIG. 10, the model 604-2 outputs the feature FB-2 (the second feature) as the inference result. In an identical manner to the model 603, the model 604-2 may be implemented using a deep learning model such as EfficientNet.

The model 602-2 uses the inferencing result of the models 601, 603, and 604-2; and outputs the final inference result. In the example illustrated in FIG. 10, the model 602-2 is trained to perform the inference using the features FA, FB-1, and FB-2.

In an identical manner to the first embodiment, the models 601, 603, and 604-2 may output probability information as the inference result instead of outputting the features. In that case, the model 602-2 outputs the inference result using a variety of probability information. In the case where the time-series data SDB of three or more types are used, the configuration may be such that a model corresponding to each type is used in an identical manner to the explanation given earlier.

In the information processing device 100-2 according to the second embodiment, the flow of information processing is identical to FIG. 7 illustrating the information processing according to the first embodiment. Hence, that explanation is not given again.

In this way, in the second embodiment, it becomes possible to have a configuration in which the frames are selected from each of two types of time-series data.

### Third Embodiment

In the first embodiment, the degrees of attention are calculated in only a single type of time-series data. However, there may be two or more types of time-series data in which the degrees of attention are calculated. In a third embodiment, the explanation is given about an example in which the degrees of attention are calculated from each of two-types of time-series data.

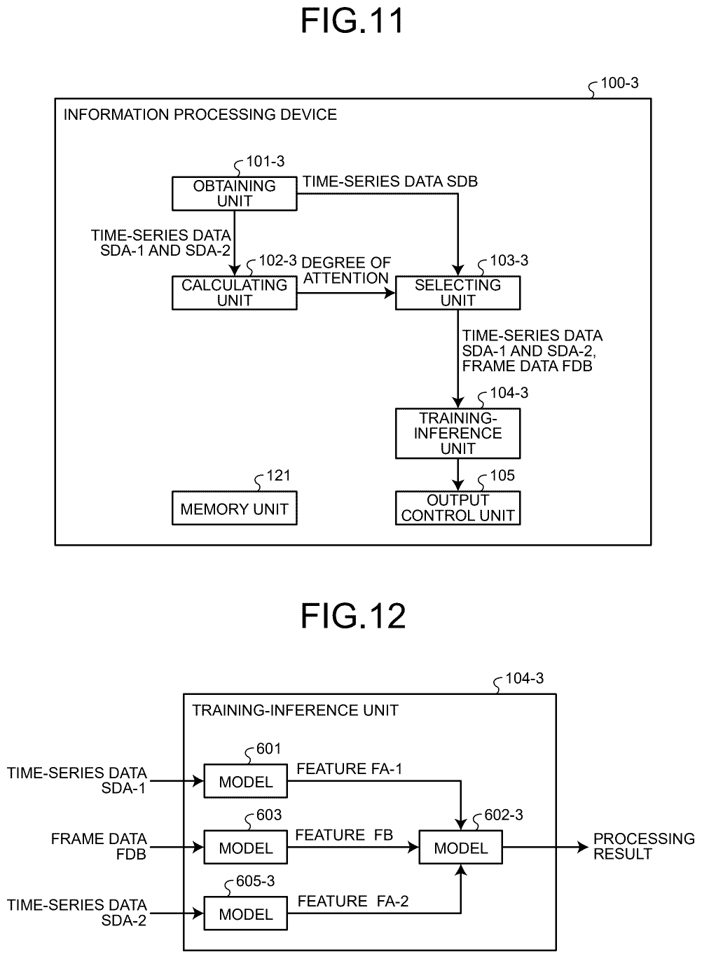

FIG. 11 is a block diagram illustrating an exemplary configuration of an information processing device 100-3 according to the third embodiment. As illustrated in FIG. 11, the information processing device 100-3 includes an obtaining unit 101-3, a calculating unit 102-3, a selecting unit 103-3, a training-inference unit 104-3, the output control unit 105, and the memory unit 121.

In the third embodiment, the obtaining unit 101-3, the calculating unit 102-3, the selecting unit 103-3, and the training-inference unit 104-3 have different functions than the functions according to the first embodiment. The other configurations and the other functions are identical to FIG. 1 illustrating the block diagram of the information processing device 100 according to the first embodiment. Hence, they are referred to by the same reference numerals, and their explanation is not given again.

The obtaining unit 101-3 obtains two pieces of time-series data SDA-1 and SDA-2 of mutually different types, and obtains a single set of time-series data SDB. For example, the time-series data SDA-1 represents skeleton sequence data; the time-series data SDB represents video data; and the time-series data SDA-2 represents sequence data of the optical flow calculated from the video data (the time-series data SDB).

The calculating unit 102-3 calculates the degree of attention of each frame in each of the pieces of time-series data SDA-1 and SDA-2. The method for calculating the degrees of attention in each set of time-series data (each of the pieces of time-series data SDA-1 and SDA-2) is identical to the method implemented by the calculating unit 102 according to the first embodiment. For example, using a model MA-1 (an example of the first model) that receives input of the time-series data SDA-1 and performs inference, a calculating unit 102-2 calculates the degree of attention of each of a plurality of frames included in the time-series data SDA-1 (hereinafter, referred to as an attention degree AD-1). Moreover, using a model MA-2 (an example of the first model) that receives input of the time-series data SDA-2 and performs inference, the calculating unit 102-2 calculates the degree of attention of each of a plurality of frames included in the time-series data SDA-2 (hereinafter, referred to as an attention degree AD-2).

Then, using the attention degrees AD-1 and the attention degrees AD-2, the selecting unit 103-3 selects N number of frames from a single set of time-series data SDB. The selecting unit 103-3 may apply the following selection methods.
selection method 2-1: frames at the same time as the frames having high values from among the attention degrees AD-1 and the attention degrees AD-2 are selected as the frame data FDB.
selection method 2-2: frames at the same time as the frames for which the total degree of attention, which is calculated based on the attention degrees AD-1 and the attention degrees AD-2, is the highest, are selected as the frame data FDB. The total degree of attention is, for example, obtained by adding the attention degrees AD-1 and the attention degrees AD-2. However, that is not the only possible method for calculating the total degree of attention, and any other method may be implemented. For example, the total degree of attention may be obtained by performing weighted addition of the attention degrees AD-1 and the attention degrees AD-2. At the time of calculating the total degree of attention, the attention degrees AD-1 and the attention degrees AD-2 may be normalized using the highest value or the average value of the attention degrees AD-1 and the highest value or the average value of the attention degrees AD-2.

The training-inference unit 104-3 uses the information based on the two pieces of time-series data SDA-1 and SDA-2 and uses the information based on the N number of frames of frame data FDB, and performs training of the model MB or inference.

FIG. 12 is a block diagram illustrating an exemplary configuration of the training-inference unit 104-3. As illustrated in FIG. 12, the training-inference unit 104-3 includes models 601, 602-3, 603, and 605-3. Regarding the same configuration as the training-inference unit 104 according to the first embodiment, the same reference numerals are used and the same explanation is not given again.

The model 601 is identical to FIG. 6, except for the fact that the time-series data SDA and the feature FA are referred to as the time-series data SDA-1 and a feature FA-1.

A model 605-2 receives input of the time-series data SDA-2 and performs inference, and outputs the inference result. In the example illustrated in FIG. 12, the model 605-2 receives input of the time-series data SDA-2 and outputs the feature FA-2 (the first feature) as the inference result. In an identical manner to the model 601, the model 605-2 may be implemented using a deep learning model such as ST-GCN.

The model 602-3 uses the inference result of the models 601, 603, and 605-3; and outputs the final inference result. In the example illustrated in FIG. 12, the model 602-3 is trained to perform the inference using the features FB and FA-2.

In an identical manner to the first embodiment, the models 601, 603, and 605-3 may output probability information as the inference result instead of outputting the features. In that case, the model 602-3 outputs the inference result using a variety of probability information. In the case where the time-series data SDA of three or more types are used, the configuration may be such that a model corresponding to each type is used in an identical manner to the explanation given earlier.

In the example illustrated in FIG. 12, both of the two pieces of time-series data SDA-1 and SDA-2 are used in inference. Alternatively, it is possible to use only some of the time-series data in inference.

In the information processing device 100-2 according to the third embodiment, the flow of information processing is identical to FIG. 7 illustrating the information processing according to the first embodiment. Hence, that explanation is not given again.

In this way, in the third embodiment, it becomes possible to have a configuration in which the degrees of attention are calculated from two types of time-series data.

As explained above, according to the first to third embodiments, it becomes possible to hold down an increase in the amount of calculation, while enhancing the accuracy of the processing performed using machine learning models.

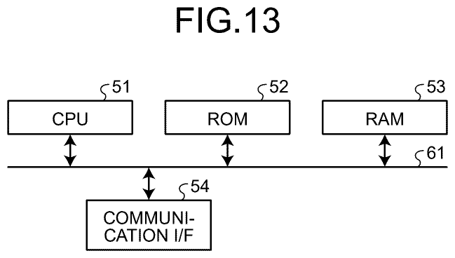

Explained below with reference to FIG. 13 is a hardware configuration of the information processing device according to the first to third embodiments. FIG. 13 is a diagram illustrating an exemplary hardware configuration of the information processing device according to the first to third embodiments.

The information processing device according to the first to third embodiments includes a control device such as a central processing unit (CPU) 51; memory devices such as a read only memory (ROM) 52 and a random access memory (RAM) 53; a communication interface (I/F) 54 that performs communication by establishing connection with a network; and a bus 61 that connects the constituent elements to each other.

A computer program executed in the information processing device according to the first to third embodiments is stored in advance in the ROM 52.

Alternatively, the computer program executed in the information processing device according to the first to third embodiments may be recorded as an installable file or an executable file in a computer-readable recording medium such as a CD-ROM (which stands for Compact Disk Read Only Memory), a flexible disk (FD), a CD-R (which stands for Compact Disk Recordable), or a DVD (which stands for Digital Versatile Disk).

Still alternatively, the computer program executed in the information processing device according to the first to third embodiments may be stored in a downloadable manner in a computer that is connected to a network such as the Internet. Still alternatively, the computer program executed in the information processing device according to the first to third embodiments may be distributed via a network such as the Internet.

The computer program executed in the information processing device according to the first to third embodiments may cause a computer to function as the constituent elements of the information processing device. In the computer, the CPU 51 reads the computer program from a computer-readable memory medium into the main memory device, and then may execute the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising one or more hardware processors configured to perform:
obtaining one or more pieces of first time-series data and one or more pieces of second time-series data, types of the one or more pieces of first time-series data being different from each other, types of the one or more pieces of second time-series data being different from the types of the one or more pieces of first time-series data and being different from each other;
calculating, regarding each of a plurality of first frames included in the first time-series data, a degree of attention indicating a degree at which attention is given in inference performed by a first model configured to receive input of the first time-series data and perform the inference;
selecting, from the second time-series data, an N number of second frames using the degree of attention, N being an integer equal to or greater than 1; and
performing training-inference including performing training of a second model configured to perform the inference or performing the inference by the second model using information based on the first time-series data and information based on the selected N number of second frames.

2. The device according to claim 1, wherein
the first model is configured to receive input of the first time-series data and output, as a result of the inference, a first feature indicating a feature of the first time-series data, and
the second model is configured to receive input of the first feature and a second feature indicating a feature of the N number of second frames, and output a result of the inference.

3. The device according to claim 1, wherein the second model is configured to:
receive input of
a first inference result representing a result of the inference output by the first model, and
a second inference result representing a result of the inference performed by a third model configured to receive input of the selected N number of second frames and perform the inference; and
output a result of the inference.

4. The device according to claim 1, wherein the first time-series data and the second time-series data have a same start time and a same end time.

5. The device according to claim 1, wherein
the first model is a model configured to, regarding each of the plurality of first frames, output a result of the inference including a degree of attention in a temporal axis, and
the calculating includes calculating the degree of attention in the temporal axis using the first model.

6. The device according to claim 5, wherein
the performing the training-inferencing includes performing training of the first model along with the training of the second model; and
when training is perform in the training-inference, the calculating includes calculating the degree of attention in the temporal axis using the first model that is being trained along with the second model.

7. The device according to claim 1, wherein the second time-series data has a greater amount of data than an amount of data of the first time-series data.

8. The device according to claim 1, wherein the selecting includes selecting a second frame at a same time as a first frame that has a highest degree of attention among the plurality of first frames.

9. The device according to claim 1, wherein
the obtaining includes obtaining two or more pieces of second time-series data, and
the selecting includes selecting the N number of second frames from each of the two or more pieces of second time-series data.

10. The device according to claim 1, wherein
the obtaining includes obtaining two or more pieces of first time-series data,
the calculating includes calculating the degree of attention for each of the two or more pieces of first time-series data, and
the selecting includes
selecting a second frame at a same time as a first frame that corresponds to a degree of attention that is largest from among two or more degrees of attention calculated regarding the two or more pieces of first time-series data, or
selecting a second frame at a same time as a first frame having a total degree of attention that is largest, the total degree of attention being calculated based on the two or more degrees of attention calculated regarding the two or more pieces of first time-series data.

11. The device according to claim 1, wherein the selecting includes selecting the N number of second frames at same times as an N number of first frames that, from among the plurality of first frames, have degrees of attention that are equal to local maximum values.

12. The device according to claim 1, wherein the one or more hardware processors are configured to further perform executing output-controlling including outputting the selected N number of second frames.

13. The device according to claim 1, wherein frames included in the first time-series data and frames included in the second time-series data represent one of color image data, skeleton data, optical flow data, depth image data, regional division image data, infrared image data, audio data, and X-ray image data.

14. A computer program product having a non-transitory computer readable medium including programmed instructions, wherein the programmed instructions, when executed by a computer, cause the computer to execute:
obtaining one or more pieces of first time-series data and one or more pieces of second time-series data, types of the one or more pieces of first time-series data being different from each other, types of the one or more pieces of second time-series data being different from the types of the one or more pieces of first time-series data and being different from each other;
calculating, regarding each of a plurality of first frames included in the first time-series data, a degree of attention indicating a degree at which attention is given in inference performed by a first model configured to receive input of the first time-series data and perform the inference;
selecting, from the second time-series data, an N number of second frames using the degree of attention, N being an integer equal to or greater than 1; and
performing training-inference including performing training of a second model configured to perform the inference or performing the inference by the second model using information based on the first time-series data and information based on the selected N number of second frames.

15. An information processing method implemented by an information processing device, comprising:
obtaining one or more pieces of first time-series data and one or more pieces of second time-series data, types of the one or more pieces of first time-series data being different from each other, types of the one or more pieces of second time-series data being different from the types of the one or more pieces of first time-series data and being different from each other;
calculating, regarding each of a plurality of first frames included in the first time-series data, a degree of attention indicating a degree at which attention is given in inference performed by a first model configured to receive input of the first time-series data and perform the inference;
selecting, from the second time-series data, an N number of second frames using the degree of attention, N being an integer equal to or greater than 1; and
performing training-inference including performing training of a second model configured to perform the inference or performing the inference by the second model using information based on the first time-series data and information based on the selected N number of second frames.
